(19) United States
(12) Patent Application Publication
(10) Pub. No.: US 2026/0154561 A1
(43) Pub. Date: Jun. 4, 2026

(54) TRAINING SUMMARIZATION NEURAL NETWORKS THROUGH REINFORCEMENT LEARNING

(71) Applicant: Google LLC, Mountain View, CA (US)

(72) Inventors: Jiaxing Wu, San Jose, CA (US); Sushant Prakash, Scarsdale, NY (US); Lin Ning, San Jose, CA (US); Luyang Liu, Redmond, WA (US); Harrison J Lee, London (GB); Jun Xie, Bellevue, WA (US)

(21) Appl. No.: 18/965,938

(22) Filed: Dec. 2, 2024

(51) Int. Cl. G06N 3/092

(52) U.S. Cl. CPC G06N 3/092

(57) ABSTRACT

Methods and systems for training a summarization neural network through reinforcement learning. As part of the training, entity context data for a particular entity can be received. A ground truth label for a downstream prediction task for the particular entity can be received. The entity context data can be processed using a summarization neural network to generate a summary of the entity context data. A predicted output for the downstream prediction task can be generated from the summary of the entity context data. A reward can be determined from the predicted output and the ground truth label. Then, the summarization neural network can be trained using the reward through reinforcement learning.

### BACKGROUND

This specification relates to processing data using neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes techniques for training a summarization model to generate summaries of data related to a particular entity using reinforcement learning. An entity can be, for example, a particular user of a device or software application, an organization of multiple users, a particular user device, or a particular session. The reinforcement learning relies on a prediction that is generated by a downstream prediction model, based on a summary generated by the summarization model.

Particular embodiments of the subject matter described in this specification can be implemented so as to realize one or more of the following advantages.

First, the techniques described in this specification allow for training a neural network that produces high-quality summaries of entity data, without the need for reference summaries or human intervention. In training a summarization neural network, a reference summary is a summary from a source external to the neural network against which summaries generated by the neural network are compared. More specifically, the reference summary, in addition to the summary generated by the neural network, is an input to the loss function which is minimized as part of the process of training the neural network. It is challenging to find a reference summary of entity data because summaries of entity data are unique to the entity and the type of content being summarized. Additionally, entity data can be specific to an entity's activities within a certain time period, and so summaries of this data are also specific to the time period to which the data refers. Also, different types of summaries can be tailored to different types of downstream tasks. Therefore, conventionally, it is difficult to train a model to produce a summary of entity data because of a lack of reference summaries. Some models are therefore trained via human feedback, in which a human reviews the summary produced by the model and provides feedback to the model on the summary. However, this manner of feedback can be difficult or impossible to obtain at scale and also compromises the privacy of the entity data.

The described techniques, by contrast, train a summarization neural network by providing feedback from a downstream prediction model, so that no human intervention is required. Reference summaries are also not required because the reward generated to train the summarization neural network is not based on the generated summary itself, but rather on the prediction made by the downstream prediction model using the summary as input. Thus, the summarization neural network can be effectively trained without human feedback and without having access to any reference summaries, alleviating the issues present in conventional approaches.

Second, the techniques described in this specification enable direct optimization of the summarization process for downstream prediction performance, without requiring excessive overhead computational costs. Conventionally, reinforcement learning models can be optimized for completion of a specified task through feedback from a dedicated trained reward Large Language Model (LLM). A dedicated trained reward LLM is a special purpose model that is trained specifically as a reward model. Therefore, employing a dedicated trained reward LLM requires additional training of the LLM, such as with specific reward labels, e.g., that are generated based on preference data collected using feedback, that are difficult to obtain, as described above. Even when training data for the reward model is available, this additional training can lead to excessive overhead computing costs.

In the techniques described in this specification, a fixed, pre-trained downstream prediction model may be used to train the summarization neural network. Thus, no training of an additional model is required, yet the summarization neural network can still be optimized for the downstream prediction task corresponding to the fixed, pre-trained downstream prediction model.

Third, the techniques described in this specification allow for entity data to be utilized in entity modeling and personalization systems in such a way that the entity data is interpretable and can be utilized by arbitrary downstream neural networks, e.g., LLMs, without further training. Conventionally, entity data has been utilized in its raw form, which can be excessively lengthy or unwieldy. Or, entity data has conventionally been embedded into a lower-dimensional space to reduce its volume, but such embeddings are difficult to interpret and require additional training of any LLM that will utilize the entity data downstream. In the techniques described in this specification, entity data is summarized in a natural language summary. The summary is compact, as compared to the entity data in its raw form, and also easily interpretable, as compared to embedded entity data.

Fourth, the techniques described in this specification allow for the production of summaries of entity data that are not only accurate in the sense that they are able to facilitate accurate predictions of future entity activity, but also intrinsically of high quality. Specifically, this method has been found to significantly improve the factuality, abstractiveness, and readability of the summaries produced, as compared to other summarization processes. One optional feature of the techniques described in this specification that helps to facilitate this outcome is the incorporation of a length reward, in addition to the reward for prediction accuracy, into the total reward on which the summarization neural network is trained.

Fifth, the techniques described in this specification have been found to generalize well to different types of downstream tasks and entity data. For example, a summarization neural network that was trained on entity data related to books that an entity recently read using the techniques described in this specification would still be able to generate effective summaries of entity data related to movies that an entity has recently watched. Also, a summarization neural network that was trained with a downstream model that takes summaries as input and generates a predicted future entity activity as output, using the techniques described in this specification, would still be able to generate summaries that performed well when provided as input to other types of downstream models, such as models that use summaries to predict entity preferences.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example reinforcement learning system.

FIG. 2 is a block diagram of an example prediction system.

FIG. 3 is a flow diagram of an example process for training a summarization neural network to generate a summary used to perform a downstream prediction task.

FIG. 4 is a flow diagram for an example process for using a summarization neural network to generate a summary used to perform a downstream prediction task.

FIG. 5 is a panel of graphs illustrating the performance of a summarization neural network trained using the techniques described herein.

FIG. 6 is a table illustrating the performance of a downstream prediction model based on receiving a summary from a summarization neural network trained using the techniques described herein.

FIG. 7 is a table illustrating the performance of a summarization neural network trained using the techniques described herein, as compared to summarization models trained using other techniques.

### DETAILED DESCRIPTION

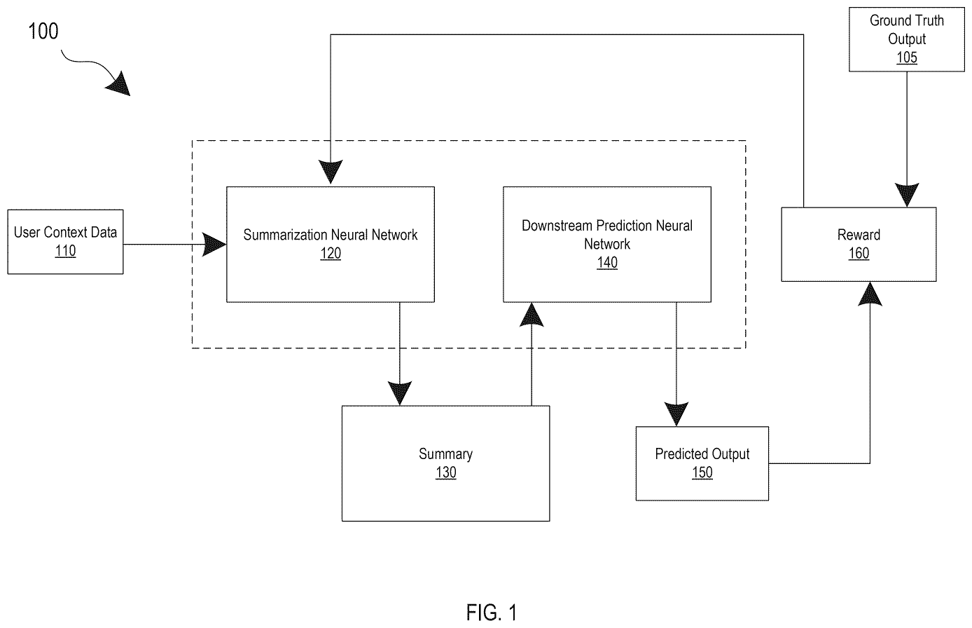

FIG. 1 is a block diagram of an example reinforcement learning system 100. The reinforcement learning system 100 is an example of a system implemented as computer programs on one or more computers in one or more locations in which the systems, components, and techniques described below are implemented.

The system 100 trains a summarization neural network 120.

The summarization neural network 120 receives as input data relating to content that an entity has interacted with and generates as output a summary of the data. For example, the summary can be a natural language summary of the input data. An entity can be, for example, a particular user of a device or software application, an organization of multiple users, a particular user device, or a particular user session with a software application or device.

The input data (also referred as “entity context data”) can include any of a variety of data. For example, the input data can be data relating to content that an entity interacts with. The input data can specify content items, such as movies, books, commodities, or locations, that an entity has historically interacted with. As a particular example, the input data can include natural language information, e.g., descriptions, of the content items interacted with by the entity.

In some implementations, the input data can be a sequence of items, where each item includes one or more features related to a specific content item. For example, each item in the sequence of items can be in the form of an array whose values represent the features of the specific content item. The values can be natural language descriptions of the features of the specific content item. The sequence of items can represent a chronologically ordered sequence of historical interactions of the entity with a particular class of content items.

The summarization neural network 120 can generally have any appropriate architecture that allows the neural network 120 to map input data characterizing content to a summary, e.g., a natural language summary. As one example, the summarization neural network 120 can be a language model neural network. The language model neural network can have any of a variety of Transformer-based neural network architectures, e.g., encoder-only Transformer architectures, encoder-decoder Transformer architectures, decoder-only Transformer architectures, other attention-based architectures, and so on.

Examples of such neural networks include those described in Colin Raffel, et al. Exploring the limits of transfer learning with a unified text-to-text transformer. arXiv preprint arXiv:1910.10683, 2019; Daniel Adiwardana, et al. Towards a human-like open-domain chatbot. CoRR, abs/2001.09977, 2020; Tom B Brown, et al. Language models are few-shot learners. arXiv preprint arXiv:2005.14165, 2020; Aakanksha Chowdhery, et al. PaLM: Scaling Language Modeling with Pathways, arXiv preprint arXiv:2204.02311; and Rohan Anil, et al. Palm 2 technical report. arXiv preprint arXiv:2305.10403, 2023.

More specifically, the system 100 trains the summarization neural network 120 through reinforcement learning using a downstream prediction neural network 140.

The downstream prediction neural network 140 receives an input that includes a summary generated by the summarization neural network 120 and generates as output a prediction corresponding to a downstream prediction task. For example, the input can include the summary and a prompt that specifies the downstream task to be performed by the neural network 140. The prediction generated by the downstream prediction neural network 140 can be, e.g., a freeform, natural language output or an output that classifies or selects one or more of a set of possible responses that are provided as part of the input to the neural network 140.

The downstream prediction task can be any task that involves generating a prediction related to the entity data that was received as input by the summarization neural network 120.

For example, the downstream prediction task can be to generate a prediction of the next content item that a particular entity will interact with. As a more specific example, if the entity data received as input by the summarization neural network 120 is a list of movies that a particular entity has watched recently, the downstream prediction task can be to generate a prediction of the next movie that the particular entity will watch.

As another example, the downstream prediction task can be to generate a prediction of the preference of a particular entity for a particular content item. As a more specific example, if the entity data received as input by the summarization neural network 120 is a list of movies that a particular entity has watched recently, the downstream prediction task can be to predict the preference of the particular entity for a particular movie, whether or not the particular movie was included in the list of movies received as input.

As part of the training, the system 100 receives both entity context data 110 and a ground truth label 105.

The entity context data 110 can be any data relating to content that an entity interacts with, as described above.

The ground truth label 105 corresponds to a downstream prediction task to be performed by the downstream prediction neural network 140. Generally, the downstream prediction task can be to generate a prediction characterizing content item interactions by the particular entity. The corresponding ground truth label 105 for the downstream prediction task can be the true characterization of the content item interactions by the particular entity.

For example, as described above, the downstream prediction task can be to generate a prediction of the next content item that the particular entity will interact with. The corresponding ground truth label 105 can be the next content item that the particular entity actually interacted with. As a more specific example, if the received entity context data 110 is a list of movies that the particular entity has watched recently, the downstream prediction task can be to generate a prediction of the next movie that the particular entity will watch. The corresponding ground truth label 105 can be the next movie that the particular entity actually watched.

As another example, as described above, the downstream prediction task can be to generate a prediction of the preference of a particular entity for a particular content item. The corresponding ground truth label 105 can be the true preference of the particular entity for the particular content item. As a more specific example, if the received entity context data 110 is a list of movies that the particular entity has watched recently, the downstream prediction task can be to predict the preference of the particular entity for a particular movie, whether or not the particular movie was included in the list of movies of the received entity context data 110. The corresponding ground truth label 105 can be the true preference of the entity for the particular movie (e.g., whether or not the entity likes the particular movie, or a rating that the entity would give to the particular movie).

The summarization neural network 120 processes the entity context data 110 to generate a summary 130 of the entity context data 110.

Next, the system 100 inputs the summary 130 into the downstream prediction neural network 140. The downstream prediction neural network 140 uses the input of the summary 130 to output a prediction corresponding to the downstream prediction task. The downstream prediction task can be any task that involves generating a prediction related to content item interactions by the particular entity, as described above.

In some implementations, the output generated by the downstream prediction neural network 140 can take the form of responding to a prompt given to the downstream prediction neural network 140. The prompt is an input to the downstream prediction neural network 140. The prompt can take the form of a natural language instruction, a set of few-shot examples, or both. The prompt can specify the task to be performed by the downstream prediction neural network 140 using the summary 130.

For example, the prompt can include a multiple-choice question, where one of the choices is the ground truth label 105. The prompt can alternatively include a question with any closed-ended format. In such implementations, the output of the downstream prediction neural network 140 can be a response to the question included in the prompt. For example, if the prompt includes a multiple-choice question, the output of the downstream prediction neural network 140 can be one of the choices.

Formatting the downstream prediction task as responding to a prompt that includes a closed-ended question helps to ensure that the summarization neural network 120 receives sufficient positive feedback, since it can be difficult to make an exact prediction without additional context due to the vast number of possibilities and potential variations.

Next, the system 100 determines a reward 160 based on the predicted output generated by the downstream prediction neural network 140 and the ground truth label 105. The reward 160 can be determined based on a comparison between the predicted output generated by the downstream prediction neural network 140 and the ground truth label 105. For example, the reward 160 can be determined based on a determination of whether the predicted output matches the ground truth label 105.

For example, the reward 160 can be a binary reward (e.g., equal to 1 if the predicted output matches the ground truth label 105, and equal to 0 otherwise). Alternatively, the reward 160 can be not binary, e.g., drawn from a continuous range of numbers whose values indicate the extent to which the predicted output matches the ground truth label 105.

In some implementations, the reward 160 can include both a prediction reward and a length reward.

The prediction reward can be based on the extent to which the predicted output generated by the downstream prediction neural network 140 matches the ground truth label 105. As described above, it can be a binary reward based on whether the predicted and ground truth labels match.

The length reward can be based on the length of the summary produced by the summarization neural network 120. For example, the length reward can be configured to reward summaries of shorter length.

As a particular example, the length reward can be based on the difference between a target summary length and the length of the summary in text tokens. For example, the length reward can be equal to the minimum of (i) an upper bound for the reward and (ii) a distance term that is based on the difference. As one example, the distance term can be equal to the product of a magnitude value and the difference. In this example, the upper bound and the magnitude value can be received as input by the system or can be determined by the system, e.g., through a hyperparameter search.

In these implementations the reward 160 can be a combination of the prediction reward and the length reward. For example, the reward 160 can be a linear combination of, e.g., a sum or a weighted sum of, the prediction reward and the length reward.

Once the system 100 determines the reward 160, it uses the reward 160 to train the summarization neural network 120 through reinforcement learning. The training of the summarization neural network 120 through reinforcement learning using the reward 160 will be described in more detail below.

Once the summarization neural network 120 has been trained, the system 100 can use the trained summarization neural network 120 to generate summaries for use in downstream tasks. For example, the system 100 can input entity data to the summarization neural network 120 that is different from the entity context data 110 on which it was trained. The summarization neural network 120 can then generate a summary of the input entity data. The generated summary can then be used for any of a variety of downstream tasks.

The downstream task for which the generated summary is used can include providing the generated summary as input to a downstream model that is either the same as or different from the downstream prediction neural network 140.

For example, the downstream task for which the generated summary is used can be the same task that was used in training the summarization neural network 120. As a more specific example, the summary can be provided as input to the downstream prediction neural network 140 that was used to train the summarization neural network 120. The downstream prediction neural network 140 can then produce a predicted output based on the summary with which it is provided, where the predicted output corresponds to the same downstream task that was used in training the summarization neural network 120.

As another example, the downstream task for which the generated summary is used can be a different task than what was used in training the summarization neural network 120. In particular, the summary can be provided as input to a second downstream prediction neural network which performs a different prediction task than the downstream prediction neural network 140. For example, if the downstream prediction neural network 140 predicts a future content item to be interacted with by an entity, the second downstream prediction neural network can make a different type of prediction, such as predicting a preference of an entity for a particular content item or set of content items.

The second downstream prediction neural network can be a downstream prediction neural network that is different from the downstream prediction neural network 140. Alternatively, the second downstream prediction neural network can be the same as the downstream prediction neural network 140. In this case, the second downstream prediction neural network can receive a different prompt than it did during the training of the summarization neural network 120, which causes it to perform a different downstream prediction task.

As another example, a downstream task for which the generated summary is used that is a different task than what was used in training the summarization neural network 120 can be a task other than a prediction task. As a more specific example, the downstream task can be to generate a review for an entity for a particular content item or set of content items such that the generated review corresponds to the entity data which is summarized in the generated summary.

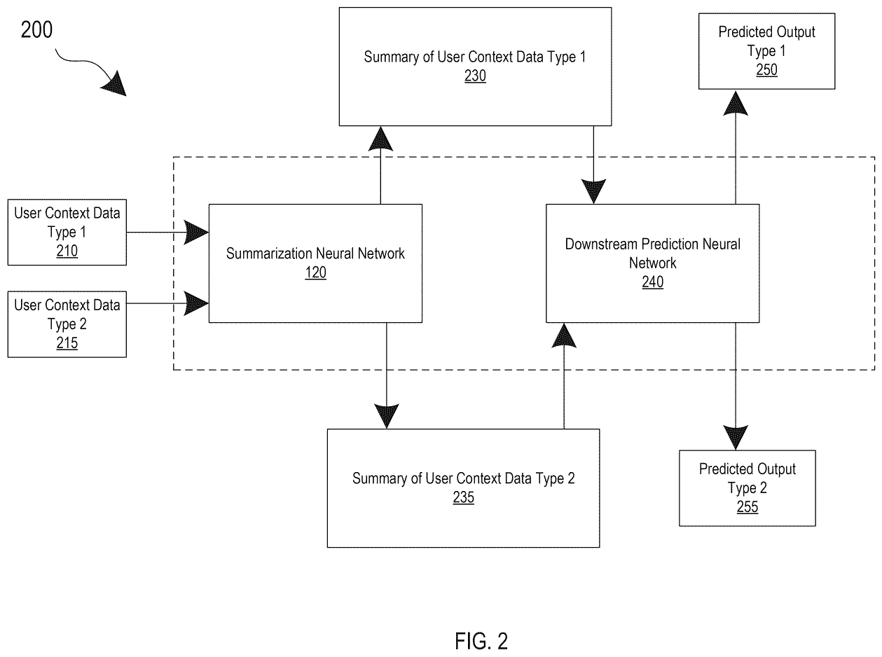

FIG. 2 is a block diagram of an example prediction system 200. The prediction system 200 is an example of a system implemented as computer programs on one or more computers in one or more locations in which the systems, components, and techniques described below are implemented.

The system 200 uses a summarization neural network 120 to make predictions based on entity data.

The summarization neural network 120 receives as input data relating to content that an entity has interacted with and generates as output a summary of the data. For example, the summary can be a natural language summary of the input data.

The input data can include any of a variety of data. For example, the input data can be data relating to content that an entity interacts with. The input data can specify content items, such as movies, books, commodities, or locations, that an entity has historically interacted with. In some implementations, the input data can be a sequence of items, where each item includes one or more features related to a specific content item. For example, each item in the sequence of items can be in the form of an array whose values represent the features of the specific content item. The values can be natural language descriptions of the features of the specific content item. The sequence of items can represent a chronologically ordered sequence of historical interactions of the entity with a particular class of content items.

The summarization neural network 120 can be the same summarization neural network 120 described above in reference to FIG. 1. In particular, the summarization neural network 120 can have been trained by the example reinforcement learning system 100, as described above in reference to FIG. 1.

Similar to the summarization neural network described above in reference to FIG. 1, the summarization neural network 120 can be a language model neural network. The language model neural network can have any of a variety of architectures, such as those described above in reference to FIG. 1.

More specifically, the system 200 uses the summarization neural network 120 to make predictions based on entity data by providing the summaries generated by the summarization neural network 120 to a downstream prediction neural network 240. The downstream prediction neural network 240 can be the same downstream prediction neural network 140 on which the summarization neural network 120 was trained, as described above in reference to FIG. 1. Alternatively, the downstream prediction neural network 240 can be different from the downstream prediction neural network 140 on which the summarization neural network 120 was trained.

The downstream prediction neural network 240 receives as input a summary generated by the summarization neural network 120 and generates as output a prediction corresponding to a downstream prediction task. The downstream prediction task can be any task that involves generating a prediction related to the entity data that was received as input by the summarization neural network 120. As an example, the downstream prediction task can be any of the examples of the downstream prediction task described above in reference to FIG. 1.

As part of the process of making predictions, the summarization neural network 120 receives entity context data. The system 200 can make predictions based on various types of entity context data. In particular, even if the summarization neural network 120 was trained using a specific type of entity context data, the system 200 can make predictions based on entity context data of various types other than that specific type of entity context data.

Therefore, as an example, the summarization neural network 120 can receive both a first type of entity context data type 210, and a second type of entity context data 215, where the second type is different from the first type.

Each of the first type of entity context data 210 and the second type of entity context data 215 can be any data relating to content that an entity interacts with. In particular, each of the first type of entity context data 210 and the second type of entity context data 215 can include data specifying content items, such as movies, books, commodities, or locations, that an entity has historically interacted with. In some implementations, each of the first type of entity context data 210 and the second type of entity context data 215 can be a sequence of items, where each item includes one or more features related to a specific content item. For example, each item in the sequence of items can be in the form of an array whose values represent the features of the specific content item. The values can be natural language descriptions of the features of the specific content item. The sequence of items can represent a chronologically ordered sequence of historical interactions of the entity with a particular class of content items.

The summarization neural network 120 processes the first type of entity context data 210 to generate a summary of the first type of entity context data 230 and processes the second type of entity context data 215 to generate a summary of the second type of entity context data 235.

Next, the system 200 inputs each of the summary of the first type of entity context data 230 and the summary of the second type of entity context data 235 into the downstream prediction neural network 240.

The downstream prediction neural network 240 uses the input of the summary of the first type of entity context data 230 to output a first predicted output 250 associated with the downstream prediction task corresponding the downstream prediction neural network 240. Additionally, the downstream prediction neural network 240 uses the input of the summary of the second type of entity context data 235 to output a second predicted output 255 associated with the downstream prediction task corresponding to the downstream prediction neural network 140. The downstream prediction task can be any task that involves generating a prediction related to content item interactions by the particular entity, as described above.

Each of the first predicted output 250 and the second predicted output 255 can result from the same downstream prediction task performed by the downstream prediction neural network 240. However, the first predicted output 250 results from performance of the downstream prediction task based on the summary of the first type of entity context data 230. Meanwhile, the second predicted output 255 results from performance of the downstream prediction task based on the summary of the second type of entity context data 235. Thus, the content of the first predicted output 250 can differ from the content of the second predicted output 255, even if they are the same type of predicted output produced in response to the same downstream prediction task, since they are each ultimately based on different types of entity context data.

Entities can utilize the outputs of the prediction system 200, such as the first predicted output 250 and the second predicted output 255, for a variety of purposes. For example, business entities can utilize the outputs to determine customer preferences, and thus be able to better tailor their products to those preferences. As another example, web applications, such as web browsers or streaming services, can utilize the outputs to gain a better understanding of the content items an entity has historically interacted with in order to be able to better suggest to the entity new content items with which to interact.

As another example, the system 200 can be part of a content recommendation system that recommends content to entities. The content items can be any appropriate type of content item, e.g., a video, an electronic book, a software application, a news article, a web page, a music content item, e.g., a song, a web page or other resource describing a product, and so on. For example, the system can predict the rating as part of making a content item recommendation for the entity.

The system can generate the content item recommendation in any appropriate context. For example, the content recommendation system can generate content recommendations during a conversation between the entity and one or more other entities, e.g., another entity or a chatbot or both. As another example, the system can generate content recommendations in response to search queries submitted by the entity to a search engine, e.g., an Internet search engine that searches web pages on the Internet, an image search engine that searches a repository of images, a video search engine that searches a repository of videos, an app store search engine that searches a repository of software applications that are available for download, an electronic book store search engine that searches a repository of electronic books, and so on.

Generally, after the system generates a recommendation of a given content item, the system or another system presents the recommended content item to the entity, e.g., on an entity device of the entity. For example, the system can provide the content item for presentation to an entity or provide a search result that identifies the content item and that, when selected by an entity, causes the content item to be presented to the entity.

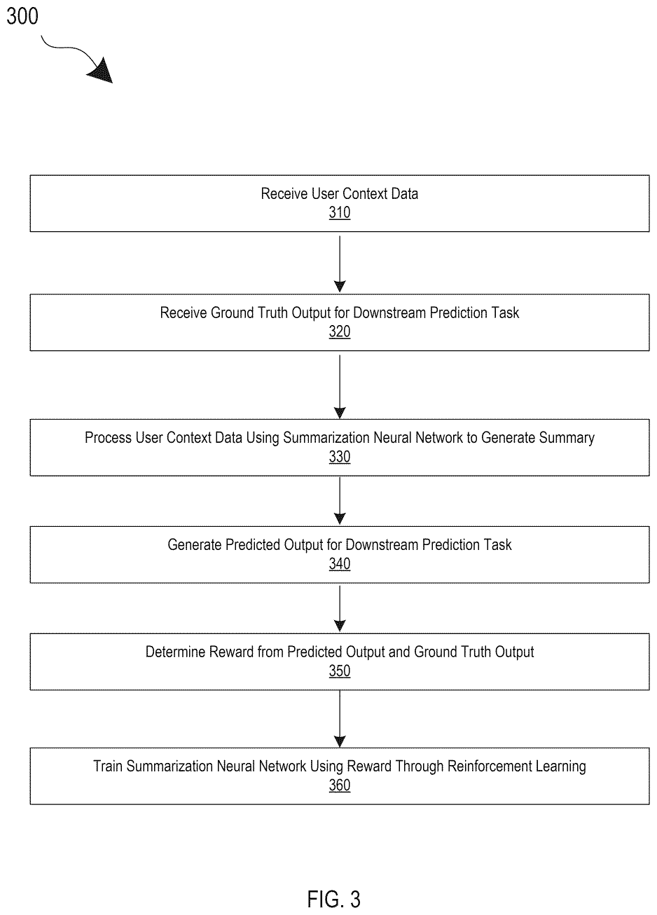

FIG. 3 is a flow diagram of an example process 300 for training a summarization neural network to generate a summary used to perform a downstream prediction task. For convenience, the process 300 will be described as being performed by a system of one or more computers located in one or more locations. For example, a reinforcement learning system, e.g., the reinforcement learning system 100 depicted in FIG. 1, appropriately programmed in accordance with this specification, can perform the process 300.

In general, the system can repeatedly perform iterations of the process 300 to fine-tune the summarization neural network for generating the summary used to perform the downstream prediction task. That is, the system can continue performing iterations of the process 300 until termination criteria for the fine-tuning of the summarization neural network on one or more downstream tasks have been satisfied, e.g., until the parameters have converged, until a threshold amount of wall clock time has elapsed, or until a threshold number of iterations of the process 300 have been performed.

The downstream prediction task for which the generated summary is used can include any prediction task characterizing content item interactions by a particular entity. For example, the downstream prediction task can include predicting the next content item in a given class of content items with which a particular entity will interact. As another example, the downstream task can include predicting a preference of a particular entity for a particular content item.

The system receives entity context data (step 310). The entity context data can include any of a variety of data. For example, the entity context data can be data relating to content that a particular entity interacts with. The entity context data can specify content items, such as movies, books, commodities, or locations, that a particular entity has historically interacted with.

In some implementations, the entity context data can be a sequence of items, where each item includes one or more features related to a specific content item, as described above in reference to FIG. 1.

The system receives a ground truth label for a downstream prediction task (step 320). The ground truth label corresponds to a downstream prediction task to be performed by a downstream prediction neural network. Generally, the downstream prediction task can include generating a prediction characterizing content item interactions by the particular entity. The downstream prediction task can include the same downstream prediction task as the task for which the summary generated by the trained summarization neural network will be used, as described above.

In implementations in which the downstream prediction task includes generating a prediction that characterizes content item interactions by a particular entity, the corresponding ground truth label for the downstream prediction task can be the true characterization of the content item interactions by the particular entity. Examples of the ground truth label for a variety of downstream prediction tasks are described above in reference to FIG. 1.

The system processes the entity context data received at step 310 using a summarization neural network to generate a summary corresponding to the entity context data (step 330). The summarization neural network can be a language model neural network. The language model neural network can have any of a variety of Transformer-based neural network architectures, e.g., encoder-only Transformer architectures, encoder-decoder Transformer architectures, decoder-only Transformer architectures, other attention-based architectures, and so on. Examples of the summarization neural network used to process the entity context data are described above in reference to FIG. 1.

The summary generated at step 330 summarizes the entity context data. The summary can be a natural language summary.

The system uses a downstream prediction neural network to generate a predicted output corresponding to the downstream prediction task (step 340). The downstream prediction task is the same downstream prediction task for which the system received the ground truth label at step 320. The downstream prediction neural network receives an input that includes the summary generated by the summarization neural network at step 330. The downstream prediction neural network generates the predicted output based on the summary it receives.

In some implementations, the output generated by the downstream prediction neural network can take the form of responding to a prompt given to the downstream prediction neural network. The prompt is an input to the downstream prediction neural network. The prompt can take a variety of formats, as described above in reference to FIG. 1. In particular, the prompt can include a multiple-choice question or any other form of closed-ended question. As described above, formatting the downstream prediction task as responding to a prompt that includes a closed-ended question helps to ensure that the summarization neural network receives sufficient positive feedback in training, since it can be difficult to make an exact prediction without additional context due to the vast number of possibilities and potential variations.

The system determines a reward based on the predicted output generated by the downstream prediction neural network and the ground truth label received (step 350). The reward can be determined based on a comparison between the predicted output generated by the downstream prediction neural network and the ground truth label, as described above in reference to FIG. 1.

In particular, the reward can be a determination of whether the predicted output matches the ground truth label. The reward can be binary or not binary. The reward can include both a prediction reward and a length reward. The reward can be a combination or a linear combination of a prediction reward and a length reward.

Once the system determines the reward, it trains the summarization neural network using the reward through reinforcement learning (step 360). The system can train the summarization neural network through any reinforcement learning algorithm, such as REINFORCE. In training the summarization neural network, a policy model and a value model of the summarization neural network can be initialized from a frozen model. In updating the policy model during training, a KL divergence term between the current policy and the initial policy can be used. As a specific example, the policy model of the summarization neural network can be updated according to the following rule:

$$θ ← θ + [ ( 1 - α ) {∇}_{θ} E [ {r}_{i} ] - α E [ {∇}_{θ} KL ( {π}_{0} \vert \vert {π}_{init} ) ] ]$$

where θ represents the policy parameters, α is a hyperparameter controlling the balance between the reward maximization and policy regularization objectives, π is the policy, init represents the frozen values of the parameters used to initialize the summarization neural network, E is the expectation operator and rᵢ is the reward determined for the i^{th} training datum, so that the E[rᵢ] term measures the expected reward for a given training datum.

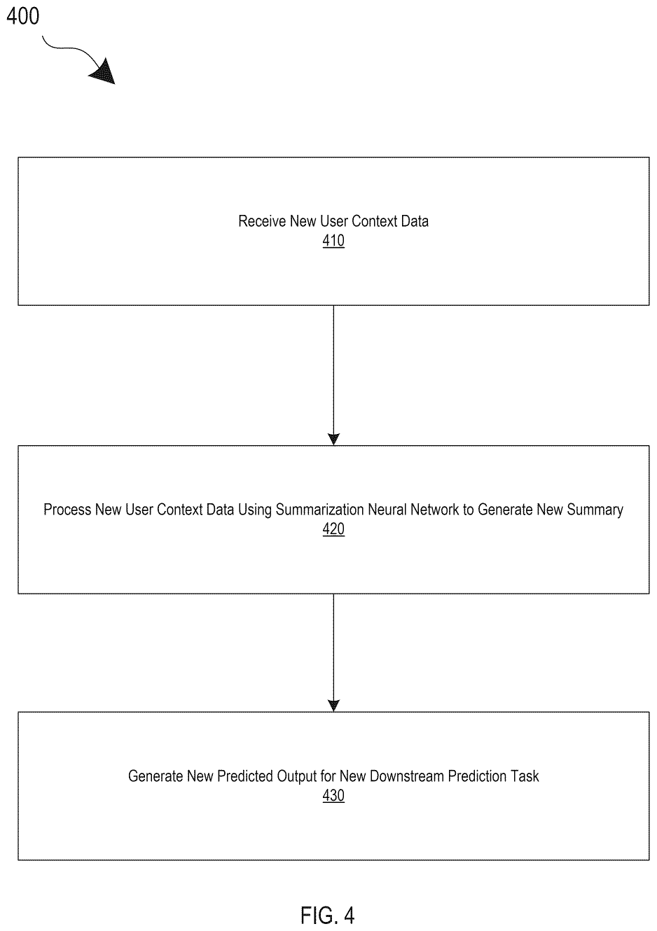

FIG. 4 is a flow diagram for an example process 400 for using a summarization neural network to generate a summary used to perform a downstream prediction task. For convenience, the process 400 will be described as being performed by a system of one or more computers located in one or more locations. For example, a prediction system, e.g., the prediction system 200 depicted in FIG. 2, appropriately programmed in accordance with this specification, can perform the process 400.

The summarization neural network used in the process 400 can be the same summarization neural network described above in reference to FIG. 3. In particular, the summarization neural network used in the process 400 can have been trained via the process 300 for training a summarization neural network described above in reference to FIG. 3.

The system receives new entity context data (step 410). The new entity context data can include any of a variety of data. For example, the new entity context data can be data relating to content that an entity interacts with. The new entity context data can specify content items, such as movies, books, commodities, or locations, that an entity has historically interacted with. In some implementations, the new entity context data can be a sequence of items, where each item includes one or more features related to a specific content item, as described above in reference to FIG. 1.

In some implementations, the new entity context data can relate to content interactions by the same entity whose content interactions were represented by the entity context data used to train the summarization neural network, such as the entity context data described above in reference to FIG. 3. Alternatively, in some implementations, the new entity context data can relate to content interactions by a different entity from the entity whose content interactions were represented by the entity context data used to train the summarization neural network, such as the entity context data described above in reference to FIG. 3.

In some implementations, the new entity context data can relate to content interactions with the same class of content items as the class of content items corresponding to the content interactions that were represented by the entity context data used to train the summarization neural network, such as the entity context data described above in reference to FIG. 3. Alternatively, in some implementations, the new entity context data can relate to content interactions with a different class of content items from the class of content items corresponding to the content interactions that were represented by the entity context data used to train the summarization neural network, such as the entity context data described above in reference to FIG. 3.

For example, if the summarization neural network was trained using entity context data that represents the books that a particular entity has read in a previous time period, the new entity context data can also be books that the same particular entity has read, perhaps in a different time period from the previous time period. Alternatively, the new entity context data can be books that a different entity, distinct from the particular entity, has read in a time period. Alternatively, the new entity context data can be movies that the same particular entity has watched in a time period. Alternatively, the new entity context data can be movies that a different entity, distinct from the particular entity, has watched in a time period.

The system processes the new entity context data using the summarization neural network to generate a new summary of the new entity context data (step 420). The new summary generated at this step summarizes the new entity context data. The new summary can be a natural language summary.

The system uses a new downstream prediction neural network to generate a new predicted output for a new downstream prediction task (step 430). The new downstream prediction neural network can be the same downstream prediction neural network on which the summarization neural network was trained, as described above in reference to FIG. 3. Alternatively, the new downstream prediction neural network can be different from the downstream prediction neural network on which the summarization neural network was trained.

The new downstream prediction neural network receives as input the new summary generated by the summarization neural network and generates a new predicted output corresponding to a new downstream prediction task. The new downstream prediction task can be any task that involves generating a prediction related to the new entity context data that was received as input by the summarization neural network. As an example, the new downstream prediction task can be any of the examples of the downstream prediction task described above in reference to FIG. 1.

The new downstream prediction task can be the same as or different from the downstream prediction task on which the summarization neural network was trained. This demonstrates one of the advantages of the techniques disclosed herein. Namely, the training of a summarization neural network using the techniques disclosed herein allows the summaries generated by the trained summarization neural network to generalize well to different types of downstream tasks and entity data.

For example, if the summarization neural network used in the process 400 was trained on entity data related to movies that an entity recently watched using the techniques described in this specification, the summarization neural network would still be able to generate effective summaries of entity data related to locations that an entity has recently visited. Also, if the summarization neural network used in the process 400 that was trained with a downstream model that takes summaries as input and generates a predicted future entity activity as output, using the techniques described in this specification, the summarization neural network would still be able to generate summaries that performed well when used to perform different downstream prediction tasks, such as using summaries to predict entity preferences.

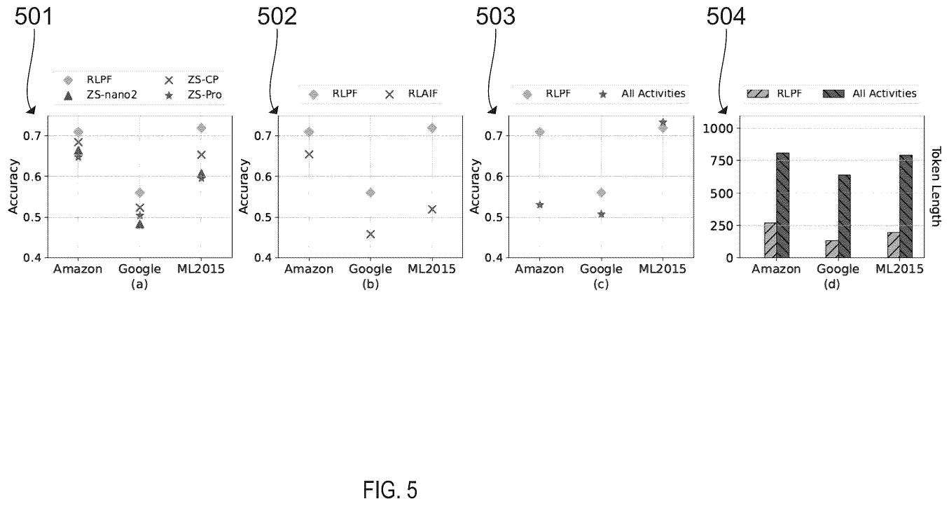

FIG. 5 is a panel of graphs illustrating the advantageous performance of a summarization neural network trained using the techniques described herein. Graph (a) illustrates the accuracy in the performance of a downstream prediction task using a summary generated by a summarization neural network trained using the techniques described herein relative to that of other summarization models. In particular, the x-axis (i.e., horizontal axis) of the graph includes three points representing three distinct training data sets used to train each of the summarization models. The y-axis (i.e., vertical axis) of the graph represents the accuracy in the performance of a downstream task related to predicting future entity activity by a downstream prediction model that received as input a summary generated by each of the summarization models.

A downstream prediction task related to predicting future entity activity was selected for the purpose of comparing the effectiveness of the summaries produced by each of the summarization models. Each of the summarization models was trained on three distinct training data sets (“Amazon”, “Google”, and “ML2015”). For each training data set, each of the summarization models then received new data, distinct from any data in the training data set. For each training data set on which each summarization model was trained, the summarization model generated a summary based on the new data that it received. For each summary, a downstream prediction model used the summary to perform the selected downstream prediction task.

Each of the points plotted on graph (a) thus represents the accuracy in the performance of the selected downstream prediction task by the downstream prediction model using the summary generated by each of the summarization models for each of the training datasets. In particular, the diamond-shaped points represent the accuracy corresponding to the summarization model trained using the techniques disclosed herein. The x-shaped points represent the accuracy corresponding to the Gemini 1.0 Nano-2 summarization model, with custom designed prompts optimized for downstream tasks. The triangle-shaped points represent the accuracy corresponding to the Gemini Nano-2 Zero-Shot summarization model. The star-shaped points represent the accuracy corresponding to the Gemini Pro Zero-Shot summarization model. The graph illustrates that the techniques disclosed herein for training a summarization neural network cause the trained summarization neural network to generate summaries that, when fed to a downstream prediction model, allow for more accuracy in the performance of a downstream prediction task, as compared to other summarization models.

Graph (b) illustrates the accuracy in the performance of a downstream prediction task using a summary generated by a summarization neural network trained using the techniques described herein relative to that of a summarization model trained using reinforcement learning from artificial intelligence feedback (RLAIF). In this case, the summarization model trained using RLAIF used Gemini 1.0 Nano-2 as the policy model, and derived the reward signal from scores provided by a Gemini 1.0 Pro large language model. This graph reflects the results of the same procedure that was described above in reference to graph (a), i.e., selecting a task, training each model on three training data sets, having each model generate a summary based on new data, and using the summary as input to a downstream prediction model to perform a downstream prediction task.

The x and y axes of graph (b) represent the same quantities as in graph (a), as described above. The graph illustrates that the techniques disclosed herein for training a summarization neural network cause the trained summarization neural network to generate summaries that, when fed to a downstream prediction model, allow for more accuracy in the performance of a downstream prediction task, as compared to a summarization model trained using RLAIF.

Graph (c) illustrates the accuracy in the performance of a downstream prediction task using a summary generated by a summarization neural network trained using the techniques described herein relative to the performance of the same downstream prediction task by a model that used a list of all of the activities of an entity, rather than a summary. In this case, the model that used the list of all the activities of the entity was a Gemini 1.0 Pro model.

As described above, a downstream prediction task related to predicting future entity activity was selected for the purpose of comparing the effectiveness of the inputs of a summary and of a list of all the activities of an entity. The summarization model was trained on three distinct training data sets (“Amazon”, “Google”, and “ML2015”). For each training data set, the summarization model received new data, distinct from any data in the training data set, and generated a summary based on the received new data. For each summary, a downstream prediction model used the summary to perform the selected downstream prediction task. For each training data set, the downstream prediction model also used a list of all the activities of the entity to perform the same selected downstream prediction task. The results of the task performed using the summary were compared to the results of the task performed using the list of all the activities of the entity.

The x and y axes of graph (c) represent the same quantities as in graph (a), as described above. The diamond-shaped points on the graph represent the accuracy corresponding to the summarization model trained using the techniques disclosed herein. The star-shaped points represent the accuracy corresponding to the model that used the list of all of the activities of the entity. The graph illustrates that the techniques disclosed herein for training a summarization neural network cause the trained summarization neural network to generate summaries that, when fed to a downstream prediction model, allow for more accuracy in the performance of a downstream prediction task for two out of the three training data sets used, as compared to the performance of the downstream prediction task by a model based on a list of all of an entity's activities.

Graph (d) illustrates the length of the input into a downstream prediction model to perform the downstream prediction task for each of the two instances referenced in graph (c), i.e., when the downstream prediction model performing the task receives as input a summary generated by a summarization neural network trained using the techniques described herein, and when the downstream prediction model performing the task receives as input a list of all of the activities of an entity. The x-axis (i.e., horizontal axis) of the graph has the same representation as that in the graphs previously described, i.e., it includes three points representing three distinct training data sets. The y-axis (i.e., vertical axis) of the graph represents the length of the input into the model, in number of characters or text tokens as generated by a text tokenizer.

For each point on the x-axis, the height of the left bar represents the length of the input when the downstream prediction model performing the task receives as input a summary generated by a summarization neural network trained using the techniques described herein. For each point on the x-axis, the height of the right bar represents the length of the input when the downstream prediction model performing the task receives as input a list of all of the activities of an entity.

The graph illustrates that the techniques described herein allow downstream prediction models to perform prediction tasks with inputs of smaller length, as compared to using a list of all of the activities of an entity as input. This is advantageous because inputs of longer length, such as lists of all of the activities of an entity, can include noise and/or unnecessary data that reduce the accuracy in the performance of downstream prediction tasks based on the inputs. Additionally, inputs of shorter length can improve efficiency in performing downstream prediction tasks due to their compact nature.

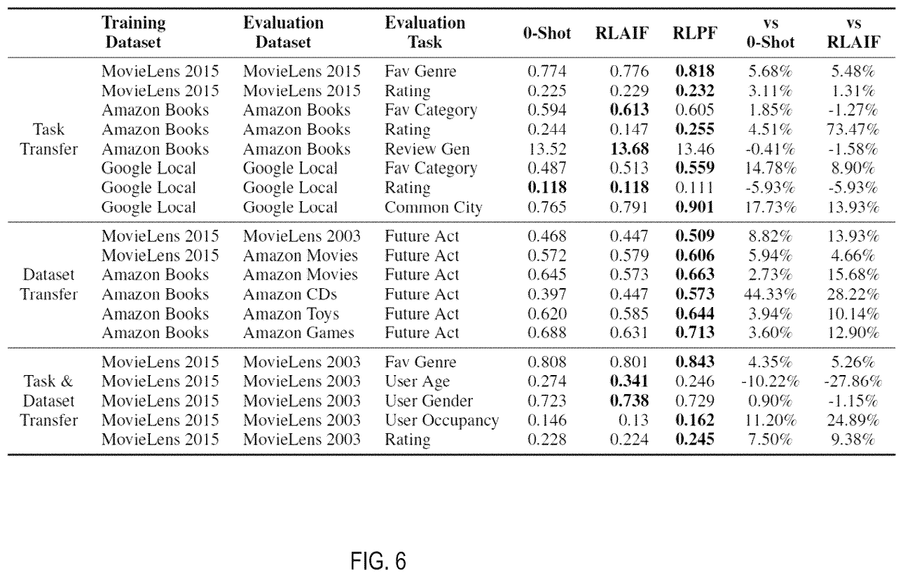

FIG. 6 is a table illustrating the accuracy in the performance of a downstream prediction model based on receiving a summary from a summarization neural network trained using the techniques described herein, in the context of different combinations of training datasets, evaluation datasets, and evaluation tasks. The three columns in the table labeled “0-Shot”, “RLAIF” and “RLPF” display values for the accuracy of the performance of the corresponding evaluation task by the downstream prediction model based on receiving the input of a summary generated using a zero-shot model, a summarization model trained using RLAIF, and a summarization model trained using the techniques described herein, respectively. For each row in the table, the models were trained on the task of future activity prediction, regardless of the evaluation task.

The table illustrates that a summarization model trained using the techniques described herein can generate summaries that are transferable and generalizable across diverse unseen tasks and datasets. For example, the downstream prediction model performed the task of predicting a common city for an entity with a 17.73% increase in accuracy when it received as input a summary generated by a summarization model trained using the techniques described herein as compared to when it received a summary generated by a zero-shot summarization model. The downstream prediction model performed the task of predicting a common city for an entity with a 13.93% increase in accuracy when it received as input a summary generated by a summarization model trained using the techniques described herein as compared to when it received a summary generated by a summarization model trained using RLAIF. This illustrates the transferability of the techniques described herein across tasks, since the summarization model was trained on the task of future activity prediction, while it was evaluated on the task of common city prediction.

Additionally, the downstream prediction model performed the task of predicting future entity activity related to Amazon CDs content with a 44.33% increase in accuracy when it received as input a summary generated by a summarization model trained on Amazon Books content using the techniques described herein as compared to when it received a summary generated by a zero-shot summarization model trained on Amazon Books content. The downstream prediction model performed the task of predicting future entity activity related to Amazon CDs content with a 28.22% increase in accuracy when it received as input a summary generated by a summarization model trained on Amazon Books content using the techniques described herein as compared to when it received a summary generated by a summarization model trained on Amazon books content using RLAIF. This illustrates the transferability of the techniques described herein across datasets, since the summarization model was trained on data related to the interaction of an entity with Amazon Books content, while the evaluation task was performed based on data related to the interaction of an entity with Amazon CDs content.

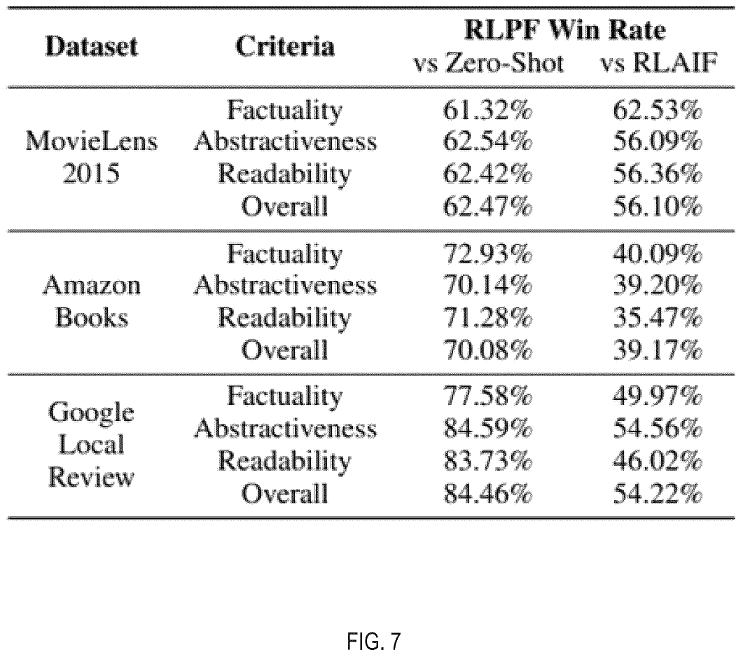

FIG. 7 is a table illustrating the improved performance of a summarization neural network trained using the techniques described herein, as compared to summarization models trained using other techniques. Each of a zero-shot summarization model, a summarization model trained using RLAIF, and a summarization model trained using the techniques described herein produced summaries based on different data sets. The summarization model trained using the techniques described herein was specifically trained on rewards based on the performance of a downstream model that used the summaries for future activity prediction. An automated rater was used to generate an evaluation of the summaries on their factuality, abstractiveness, and readability, as well as an overall evaluation of the summaries. The third column of the table labeled “RLPF Win Rate” includes entries that are values indicating the percentage of instances in which the summarization model trained using the techniques described herein produced summaries with better evaluations—in the category and for the dataset corresponding to the row of the entry—than the other models. In particular, the sub-column labeled “vs Zero Shot” includes entries that are values indicating the percentage of instances in which the summarization model trained using the techniques described herein produced summaries with better evaluations than the zero-shot summarization model. The sub-column labeled “vs RLAIF” includes entries that are values indicating the percentage of instances in which the summarization model trained using the techniques described herein produced summaries with better evaluations than the summarization model trained using RLAIF.

The table illustrates that a summarization model trained using the techniques described herein can generate summaries that tend to have better evaluation scores on the qualities of factuality, abstractiveness, and readability than summaries generated by summarization models trained using other techniques. These results show that, even though the summarization model trained using the techniques described herein underwent focused training that was based solely on rewards from future activity prediction, the summarization model was able to produce summaries that avoided degradation or overfitting to a single task, but rather were evaluated to have high intrinsic quality. This illustrates a beneficial feature of the technology described in this specification, in that the summarization model trained using the techniques described herein need not be trained using reward signals specific to certain criteria, such as factuality, abstractiveness, or readability. Rather, training the summarization model on rewards based on future activity prediction still enables the summarization model to generate summaries that are evaluated well in these other criteria. This facilitates a more efficient training process, as it avoids the need to design reward signals specific to desired criteria.

For situations in which the systems discussed here collect and/or use personal information about a user, including location information about user devices, the users may be provided with an opportunity to enable/disable or control the programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with an entity, embodiments of the subject matter described in this specification can be implemented on a computer having a display device, e.g., a CRT (cathode ray tube) or LCD (liquid crystal display) monitor, for displaying information to the entity and a keyboard and a pointing device, e.g., a mouse or a trackball, by which the entity can provide input to the computer. Other kinds of devices can be used to provide for interaction with an entity as well; for example, feedback provided to the entity can be any form of sensory feedback, e.g., visual feedback, auditory feedback, or tactile feedback; and input from the entity can be received in any form, including acoustic, speech, or tactile input. In addition, a computer can interact with an entity by sending documents to and receiving documents from a device that is used by the entity; for example, by sending web pages to a web browser on an entity's device in response to requests received from the web browser. Also, a computer can interact with an entity by sending text messages or other forms of message to a personal device, e.g., a smartphone that is running a messaging application, and receiving responsive messages from the entity in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical entity interface, a web browser, or an app through which an entity can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to an entity device, e.g., for purposes of displaying data to and receiving entity input from an entity interacting with the device, which acts as a client. Data generated at the entity device, e.g., a result of the entity interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving entity context data for a particular entity;
receiving a ground truth label for a downstream prediction task for the particular entity;
processing the entity context data using a summarization neural network to generate a summary of the entity context data;
generating, from the summary of the entity context data, a predicted output for the downstream prediction task;
determining a reward from the predicted output and the ground truth label; and
training the summarization neural network using the reward through reinforcement learning.

2. The method of claim 1, wherein generating, from the summary of the entity context data, a predicted output for the downstream prediction task comprises:
processing an input comprising the summary of the entity context data using a downstream prediction neural network to generate the predicted output.

3. The method of claim 2, wherein training the summarization neural network using the reward through reinforcement learning comprises:
training the summarization neural network using the reward through reinforcement learning while holding the downstream prediction neural network fixed.

4. The method of claim 2, wherein the input further comprises a query for the downstream prediction task.

5. The method of claim 4, wherein the downstream prediction neural network is a language model neural network.

6. The method of claim 1, wherein the summary is a natural language summary.

7. The method of claim 1, wherein determining a reward from the predicted output and the ground truth label comprises:
determining a prediction reward from the predicted output and the ground truth label;
determining a length reward from a length of the summary; and
determining the reward from the prediction reward and the length reward.

8. The method of claim 1, wherein the summarization neural network is a language model neural network.

9. The method of claim 1, wherein the entity context data comprises data specifying content items previously interacted with by the particular entity.

10. The method of claim 1, wherein the downstream prediction task is a task to generate a prediction characterizing content item interactions by the particular entity.

11. The method of claim 10, wherein the downstream prediction task is to predict a future content item to be interacted with by the particular entity.

12. The method of claim 10, wherein the downstream prediction task is to predict, given a particular content item, a preference of the particular entity for the particular content item.

13. The method of claim 1, further comprising:
after training the summarization neural network:
receiving new entity context data for a new entity;
processing the new entity context data for the new entity using the summarization neural network to generate a new summary of the new entity context data;
generating, from the new summary of the new entity context data, a new predicted output for a new downstream prediction task.

14. The method of claim 13, wherein the new downstream prediction task is different from the downstream prediction task.

15. The method of claim 13, wherein the new entity context data specifies a different type of entity context than the entity context data.

16. A system comprising one or more computers and one or more storage devices storing instructions that when executed by the one or more computers cause the one or more computers to perform operations comprising:
receiving entity context data for a particular entity;
receiving a ground truth label for a downstream prediction task for the particular entity;
processing the entity context data using a summarization neural network to generate a summary of the entity context data;
generating, from the summary of the entity context data, a predicted output for the downstream prediction task;
determining a reward from the predicted output and the ground truth label; and
training the summarization neural network using the reward through reinforcement learning.

17. The system of claim 16, wherein generating, from the summary of the entity context data, a predicted output for the downstream prediction task comprises:
processing an input comprising the summary of the entity context data using a downstream prediction neural network to generate the predicted output.

18. The system of claim 17, wherein training the summarization neural network using the reward through reinforcement learning comprises:
training the summarization neural network using the reward through reinforcement learning while holding the downstream prediction neural network fixed.

19. The system of claim 17, wherein the input further comprises a query for the downstream prediction task.

20. One or more non-transitory computer-readable storage media storing instructions that when executed by one or more computers cause the one or more computers to perform operations comprising:
receiving entity context data for a particular entity;
receiving a ground truth label for a downstream prediction task for the particular entity;
processing the entity context data using a summarization neural network to generate a summary of the entity context data;
generating, from the summary of the entity context data, a predicted output for the downstream prediction task;
determining a reward from the predicted output and the ground truth label; and
training the summarization neural network using the reward through reinforcement learning.
